(19) United States
(12) Patent Application Publication
(10) Pub. No.: US 2025/0286293 A1
(43) Pub. Date: Sep. 11, 2025

(54) CONNECTOR DEVICE AND ELECTRIC CONNECTOR

(71) Applicant: I-PEX Inc., Kyoto-shi (JP)

(72) Inventors: Hajime TAKAHASHI, Tokyo (JP); Seiya MOTOMURA, Tokyo (JP)

(21) Appl. No.: 19/220,093

(22) Filed: May 28, 2025

Related U.S. Application Data
(63) Continuation of application No. PCT/JP2023/040607, filed on Nov. 10, 2023.

(30) Foreign Application Priority Data
Dec. 19, 2022 (JP) 2022-202000

(51) Int. Cl. H01R 12/71; H01R 13/6594

(52) U.S. Cl. CPC H01R 12/716; H01R 13/6594

(57) ABSTRACT

A connector device includes an electric connector and a mating connector fitted to the electric connector. The electric connector includes a pair of first contacts, a first shell partially covering a periphery of the pair of first contacts around an axis along a fitting direction between the electric connector and the mating connector, and a first housing. The mating connector includes a pair of second contacts, a second shell partially covering a periphery of the pair of second contacts around an axis, and a second housing. When viewed from the fitting direction in the fitted state where the electric connector and the mating connector are fitted to each other, the first shell and the second shell surround a contact touching portion where the pair of first contacts and the pair of second contacts come into contact with each other around an axis.

### CROSS-REFERENCE TO RELATED APPLICATIONS

This application is a continuation application of PCT Application No. PCT/JP2023/040607, filed on Nov. 10, 2023, which claims the benefit of priority from Japanese Patent Application No. 2022-202000, filed on Dec. 19, 2022. The entire contents of the above listed PCT and priority applications are incorporated herein by reference.

### BACKGROUND

The present disclosure relates to a connector device and an electric connector.

Japanese Patent No. 6965685 discloses a receptacle connector that is mounted on a board and is fitted to a plug connector connected to a tip of a cable. The receptacle connector of Japanese Patent No. 6965685 includes a shell connected to a shell of a plug connector while covering a pair of contact members.

There has been a demand for simplifying a shell of an electric connector mounted on a board.

### SUMMARY

A connector device according to one aspect of the present disclosure includes an electric connector mounted on a first board and a mating connector mounted on a second board and fitted to the electric connector. The electric connector includes a pair of conductive first contacts electrically connected to a signal conductor of the first board, a conductive first shell electrically connected to a ground conductor of the first board and partially covering a periphery of the pair of first contacts around an axis along a fitting direction between the electric connector and the mating connector, and a first housing configured to hold the pair of first contacts and the first shell in an insulated state. The mating connector includes a pair of conductive second contacts electrically connected to a signal conductor of the second board, a conductive second shell electrically connected to a ground conductor of the second board and partially covering a periphery of the pair of second contacts around the axis, and a second housing configured to hold the pair of second contacts and the second shell in an insulated state. The pair of first contacts comes into contact with the pair of second contacts and the first shell comes into contact with the second shell in a fitted state where the electric connector and the mating connector are fitted to each other. The first shell and the second shell surround a contact touching portion where the pair of first contacts and the pair of second contacts come into contact with each other around the axis when viewed from the fitting direction in the fitted state.

In the electric connector, the first shell partially covers the periphery of the pair of first contacts around the axis. This enables simplifying the first shell as compared with a case where the first shell covers the entire periphery of the pair of first contacts around the axis. In the mating connector, the second shell partially covers the periphery of the pair of second contacts around the axis. This enables simplifying the second shell as compared with a case where the second shell covers the entire periphery of the pair of second contacts around the axis. When viewed from the fitting direction in the fitted state, the first shell and the second shell surround the contact touching portion around the axis. This improves the shielding performance in the fitted state.

The first shell may include a pair of first side surfaces facing each other and a first coupling surface coupling the pair of first side surfaces. The second shell may include a pair of second side surfaces facing each other and a second coupling surface coupling the pair of second side surfaces. The pair of first side surfaces, the pair of second side surfaces, the first coupling surface, and the second coupling surface may surround the contact touching portion around the axis when viewed from the fitting direction in the fitted state. The first shell has a so-called U-shape or H-shape with the pair of first side surfaces and the first coupling surface. The second shell has a so-called U-shape or H-shape with the pair of second side surfaces and the second coupling surface. Such shapes of the first shell and the second shell may be readily manufactured by, for example, performing bending processing or the like on a punched metal plate. This enables simplifying the first shell and the second shell. Further, when viewed from the fitting direction in the fitted state, the pair of first side surfaces, the pair of second side surfaces, the first coupling surface, and the second coupling surface surround the periphery of the contact touching portion around the axis. This improves the shielding performance in the fitted state.

The pair of second side surfaces may include a pair of protrusions protruding away from the second board. The pair of protrusions may come into contact with the pair of first side surfaces in the fitted state. A shell touching portion where the pair of protrusions and the pair of first side surfaces come into contact with each other may be closer to the first board than the contact touching portion. In the fitted state, the pair of protrusions is in contact with the pair of first side surfaces at a position closer to the first board than the contact touching portion. The distance between the second board and the first board is reduced and the length of the pair of protrusions is increased in the direction from the second board toward the first board, which increases the elastic force of the pair of protrusions.

When viewed from the fitting direction in the fitted state, the pair of first contacts may be electrically connected to the signal conductor of the first board outside a region surrounded by the first shell and the second shell. In the region surrounded by the first shell and the second shell, the pair of first contacts comes into contact with the pair of second contacts. The pair of first contacts is electrically connected to the signal conductor of the first board outside the region surrounded by the first shell and the second shell. That is, the pair of first contacts is formed both inside and outside the region surrounded by the first shell and the second shell. In such a pair of first contacts, the length from a contact point with the pair of second contacts to a contact point with the signal conductor of the first board increases, so that the elastic force of the pair of first contacts may be increased.

The electric connector may include a plurality of first units each of which includes the pair of first contacts and the first shell. The plurality of first units may be disposed along a direction orthogonal to the fitting direction and a direction orthogonal to an arrangement direction of the pair of first contacts, and may be disposed along the arrangement direction of the pair of first contacts. The mating connector may include a plurality of second units each of which includes the pair of second contacts and the second shell. The plurality of second units may be disposed along a direction orthogonal to the fitting direction and a direction orthogonal to an arrangement direction of the pair of second contacts, and may be disposed along the arrangement direction of the pair of second contacts. In the fitted state, the shielding performance may be achieved for each of the plurality of first units and the plurality of second units. As a result, the interval between the first units and the interval between the second units may be reduced, which enables the electric connector and the mating connector to achieve higher density.

The pair of first contacts may include a first connection leg portion extending along the first board and electrically connected to the signal conductor of the first board. The pair of second contacts may include a second connection leg portion extending along the second board and electrically connected to the signal conductor of the second board. In the fitted state, the first connection leg portion and the second connection leg portion may extend in directions away from each other. The first connection leg portion and the second connection leg portion extend in directions away from each other. Since the first connection leg portion and the second connection leg portion are spaced apart from each other, it may prevent the influence that the first connection leg portion and the second connection leg portion have on each other.

The pair of first side surfaces may face each other with the first connection leg portion interposed therebetween in an arrangement direction of the pair of first contacts. The pair of second side surfaces may face each other with the second connection leg portion interposed therebetween in an arrangement direction of the pair of second contacts. In the fitted state, the pair of first side surfaces may face each other with the contact touching portion interposed therebetween in the arrangement direction of the pair of first contacts, and the pair of second side surfaces may face each other with the contact touching portion interposed therebetween in the arrangement direction of the pair of second contacts. This improves the shielding performance in the arrangement direction of the pair of first contacts and the pair of second contacts.

In the fitted state, the first coupling surface may not face the second connection leg portion. The second coupling surface may not face the first connection leg portion. In the fitted state, the first coupling surface opens the second connection leg portion, and the second coupling surface opens the first connection leg portion. This improves the visibility of the first connection leg portion and the second connection leg portion.

When viewed from the fitting direction in the fitted state, the pair of first contacts may pass between the second coupling surface and the first board, extend outside a region surrounded by the first shell and the second shell, and be electrically connected to the signal conductor of the first board. The pair of first contacts is formed to extend between the second coupling surface and the first board. That is, the pair of first contacts is formed both inside and outside the region surrounded by the first shell and the second shell. In such a pair of first contacts, the length from a contact point with the pair of second contacts to a contact point with the signal conductor of the first board increases, so that the elastic force of the pair of first contacts may be increased.

In the fitted state, the first coupling surface and the second coupling surface do not have to face each other when viewed from a direction orthogonal to the fitting direction and a direction orthogonal to an arrangement direction of the pair of first contacts. In this case, the visibility of the pair of first contacts and the pair of second contacts is increased.

The first housing may be formed with a fitting hole penetrating the first housing so as to connect a main surface facing the mating connector when fitted to the mating connector and a back surface facing the first board. The second housing may be formed with a fitting protrusion protruding away from the second board with a main surface facing the electric connector when fitted to the electric connector as a base end. The fitting hole and the fitting protrusion may be fitted to each other in the fitted state. In this case, the fitting protrusion and the fitting hole function as guides at the time of fitting the electric connector and the mating connector. As a result, the reliability of the contact between the first contact and the second contact may be increased.

An electric connector according to one aspect of the present disclosure is mounted on a first board and is fitted to a mating connector mounted on a second board. The electric connector includes a pair of conductive first contacts electrically connected to a signal conductor of the first board, a conductive first shell electrically connected to a ground conductor of the first board and partially covering a periphery of the pair of first contacts around an axis along a fitting direction between the electric connector and the mating connector, and a housing configured to hold the pair of first contacts and the first shell in an insulated state. The pair of first contacts comes into contact with a pair of conductive second contacts of the mating connector and the first shell comes into contact with a conductive second shell of the mating connector in a fitted state with the mating connector. The first shell and the second shell surround a contact touching portion where the pair of first contacts and the pair of second contacts come into contact with each other around the axis when viewed from the fitting direction in the fitted state.

In the electric connector, the first shell partially covers the periphery of the pair of first contacts around the axis. This enables simplifying the first shell as compared with a case where the first shell covers the entire periphery of the pair of first contacts around the axis. When viewed from the fitting direction in the fitted state with the mating connector, the first shell and the second shell surround the contact touching portion around the axis. This improves the shielding performance in the fitted state.

According to the present disclosure, a connector device and an electric connector capable of simplifying a shell may be provided.

### BRIEF DESCRIPTION OF THE DRAWINGS

FIG. 1 is a perspective view illustrating an example of the appearance of a connector device.

FIG. 2 is a plan view of an electric connector.

FIG. 3A is a perspective view illustrating an example of the appearance of a pair of first contacts. FIG. 3B is a plan view illustrating an example of the appearance of the pair of first contacts. FIG. 3C is a side view illustrating an example of the appearance of the pair of first contacts. FIG. 3D is a bottom view illustrating an example of the appearance of the pair of first contacts.

FIG. 4A is a perspective view illustrating an example of the appearance of a first shell. FIG. 4B is a plan view illustrating an example of the appearance of the first shell. FIG. 4C is a side view illustrating an example of the appearance of the first shell. FIG. 4D is a bottom view illustrating an example of the appearance of the first shell.

FIG. 5A is a perspective view illustrating an example of the appearance of a first unit. FIG. 5B is a plan view illustrating an example of the appearance of the first unit. FIG. 5C is a side view illustrating an example of the appearance of the first unit. FIG. 5D is a bottom view illustrating an example of the appearance of the first unit.

FIG. 6 is an enlarged plan view illustrating an example of a part of the appearance of an electric connector in an enlarged manner.

FIG. 7 is an enlarged bottom view illustrating an example of a part of the appearance of the electric connector in an enlarged manner.

FIG. 8 is a side view illustrating an example of coupling by a first side shell.

FIG. 9 is a plan view of a mating connector.

FIG. 10A is a perspective view illustrating an example of the appearance of a pair of second contacts. FIG. 10B is a plan view illustrating an example of the appearance of the pair of second contacts. FIG. 10C is a side view illustrating an example of the appearance of the pair of second contacts. FIG. 10D is a bottom view illustrating an example of the appearance of the pair of second contacts.

FIG. 11A is a perspective view illustrating an example of the appearance of a second shell. FIG. 11B is a plan view illustrating an example of the appearance of the second shell. FIG. 11C is a side view illustrating an example of the appearance of the second shell. FIG. 11D is a bottom view illustrating an example of the appearance of the second shell.

FIG. 12A is a perspective view illustrating an example of the appearance of a second unit. FIG. 12B is a plan view illustrating an example of the appearance of the second unit. FIG. 12C is a side view illustrating an example of the appearance of the second unit. FIG. 12D is a bottom view illustrating an example of the appearance of the second unit.

FIG. 13 is an enlarged plan view illustrating an example of a part of the appearance of a mating connector in an enlarged manner.

FIG. 14 is an enlarged bottom view illustrating an example of a part of the appearance of the mating connector in an enlarged manner.

FIG. 15 is a side view illustrating an example of coupling by a second side shell.

FIG. 16 is a perspective view illustrating an example of the appearance of the first unit and the second unit in a fitted state.

FIG. 17 is a plan view illustrating an example of the appearance of the first unit and the second unit in a fitted state.

FIG. 18 is a cross-sectional view illustrating a cross section taken along the line xviii-xviii of FIG. 17.

FIG. 19 is a cross-sectional view illustrating a cross section taken along the line xix-xix of FIG. 17.

FIG. 20 is a perspective view illustrating an example of the appearance of a connector device according to a modification.

FIG. 21A is a perspective view illustrating an example of the appearance of a first unit according to a modification. FIG. 21B is a plan view illustrating an example of the appearance of the first unit according to the modification. FIG. 21C is a side view illustrating an example of the appearance of the first unit according to the modification. FIG. 21D is a bottom view illustrating an example of the appearance of the first unit according to the modification.

### DETAILED DESCRIPTION

In the following description, with reference to the drawings, the same reference numbers are assigned to the same components or to similar components having the same function, and overlapping description is omitted.

### Connector Device

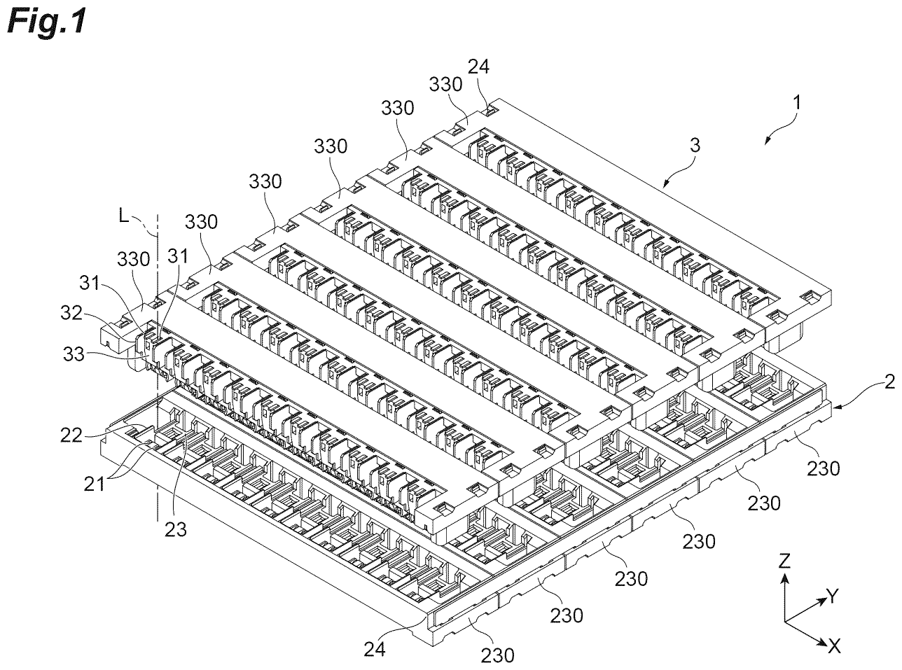

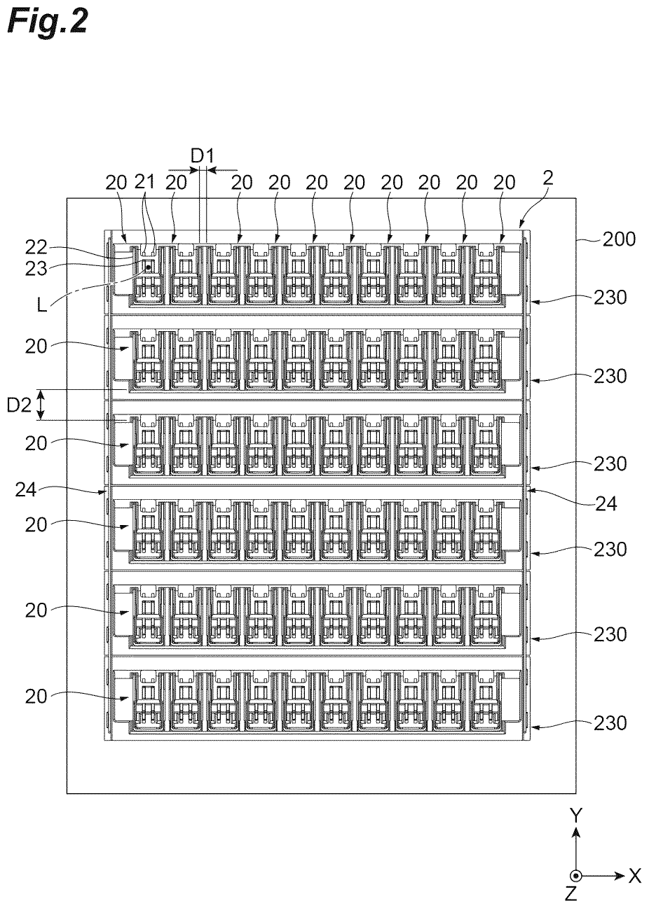

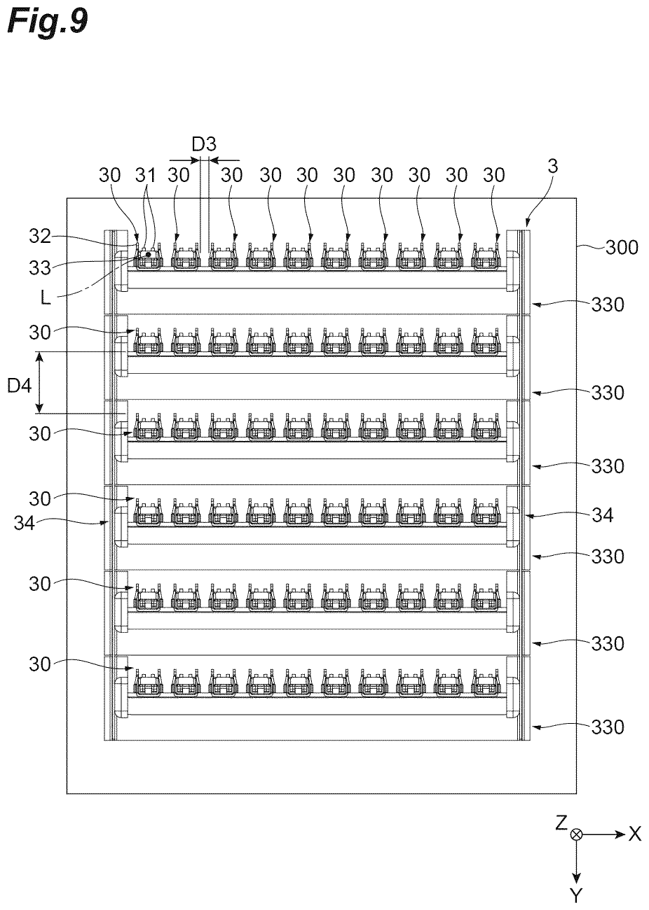

FIG. 1 is a perspective view illustrating an example of the appearance of a connector device 1 according to the present disclosure. The connector device 1 is, for example, a device used for connecting printed circuit boards in an electronic device. The connector device 1 includes an electric connector 2 mounted on a first board 200 (see FIG. 2) and a mating connector 3 mounted on a second board 300 (see FIG. 9) and fitted to the electric connector 2. In the connector device 1, the electric connector 2 and the mating connector 3 are fitted to each other along the Z-axis direction. The electric connector 2 and the mating connector 3 are fitted to each other, so that the first board 200 and the second board 300 are electrically connected. Hereinafter, the Z-axis direction is referred to as a fitting direction. When viewed from the fitting direction, each of the electric connector 2 and the mating connector 3 takes on a form approximating a rectangular shape. Hereinafter, when viewed from the fitting direction, the short side direction of the rectangular electric connector 2 and the rectangular mating connector 3 is referred to as an X-axis direction, and the long side direction thereof is referred to as a Y-axis direction. The X-axis direction, the Y-axis direction, and the Z-axis direction are orthogonal to each other.

### Electric Connector

FIG. 2 is a plan view of the electric connector 2. The electric connector 2 is, for example, a receptacle connector, and is mounted on the first board 200. The first board 200 is, for example, a printed circuit board. The first board 200 is formed with a plurality of signal conductors (conductors forming a part of a signal circuit) (not illustrated) and a plurality of ground conductors (conductors forming a part of a ground circuit) (not illustrated). The electric connector 2 includes a pair of first contacts 21, a first shell 22, a first housing 23, and a pair of first side shells 24. The electric connector 2 includes a plurality of first units 20 each of which includes the pair of first contacts 21 and the first shell 22.

The pair of first contacts 21 is electrically connected to the signal conductors of the first board 200. The pair of first contacts 21 transmits a plurality of types of differential signals. Examples of the plurality of types of differential signals include a high-speed signal and a low-speed signal. The pair of first contacts 21 is disposed side by side while being spaced apart from each other along the X-axis direction. Hereinafter, the X-axis direction is also referred to as an arrangement direction.

The first shell 22 is formed of a conductive metal plate, for example, and is electrically connected to the ground conductors of the first board 200. The first shell 22 partially covers the periphery of the pair of first contacts 21 around an axis L along the fitting direction. For example, the first shell 22 covers the periphery of the pair of first contacts 21 from two directions in the X-axis direction and one direction in the Y-axis direction. The first shell 22 is not tubular.

The first housing 23 is formed of an insulating resin, for example, and holds therein the pair of first contacts 21 and the first shell 22 in an insulated state. The first housing 23 holds therein the plurality of first units 20. The first housing 23 includes a plurality of blocks 230 each of which holds therein the plurality of first units 20 along the X-axis direction and which is arranged side by side along the Y-axis direction.

The plurality of first units 20 is disposed along a direction orthogonal to the fitting direction and a direction orthogonal to the arrangement direction of the pair of first contacts 21, and is also disposed along the arrangement direction of the pair of first contacts 21. That is, the plurality of first units 20 is disposed along the X-axis direction and the Y-axis direction. The number of first units 20 is not limited. In one example, the number of first units 20 may be 60. In this case, 10 first units 20 disposed along the X-axis direction may be arranged in 6 sets along the Y-axis direction. An interval D1 between the plurality of first units 20 adjacent to each other in the X-axis direction may be smaller than an interval D2 between the plurality of first units 20 adjacent to each other in the Y-axis direction.

The pair of first side shells 24 is formed of a conductive metal plate, for example, and is a coupling member that couples the plurality of blocks 230 of the first housing 23 along the Y-axis direction. The pair of first side shells 24 is disposed at both ends of the plurality of blocks 230 in the X-axis direction. The pair of first side shells 24 engages with each of the plurality of blocks 230 to couple the plurality of blocks 230.

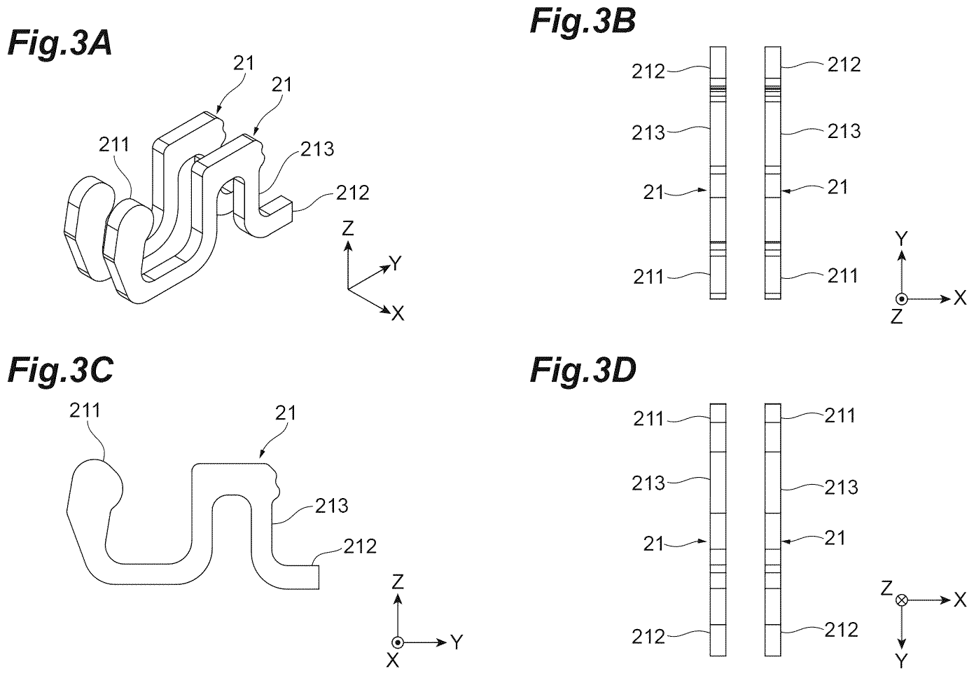

FIG. 3A is a perspective view illustrating an example of the appearance of the pair of first contacts 21. FIG. 3B is a plan view illustrating an example of the appearance of the pair of first contacts 21. FIG. 3C is a side view illustrating an example of the appearance of the pair of first contacts 21. FIG. 3D is a bottom view illustrating an example of the appearance of the pair of first contacts 21.

As illustrated in FIG. 3B and FIG. 3D, the pair of first contacts 21 extends along the Y-axis direction when viewed from the fitting direction. As illustrated in FIG. 3C, the pair of first contacts 21 takes on a form approximating an S shape when viewed from the arrangement direction. The pair of first contacts 21 is formed by, for example, performing bending processing or the like on a punched metal plate. Each of the pair of first contacts 21 includes a first contact portion 211, a first connection leg portion 212, and a first coupling portion 213.

The first contact portion 211 protrudes along the Z-axis direction so as to be spaced apart from the first board 200. The first connection leg portion 212 extends along the first board 200 and is electrically connected to the signal conductors of the first board 200. The first coupling portion 213 couples the first contact portion 211 and the first connection leg portion 212. The first coupling portion 213 is formed in a crank shape by extending away from the first board 200 and then bending toward the first board 200.

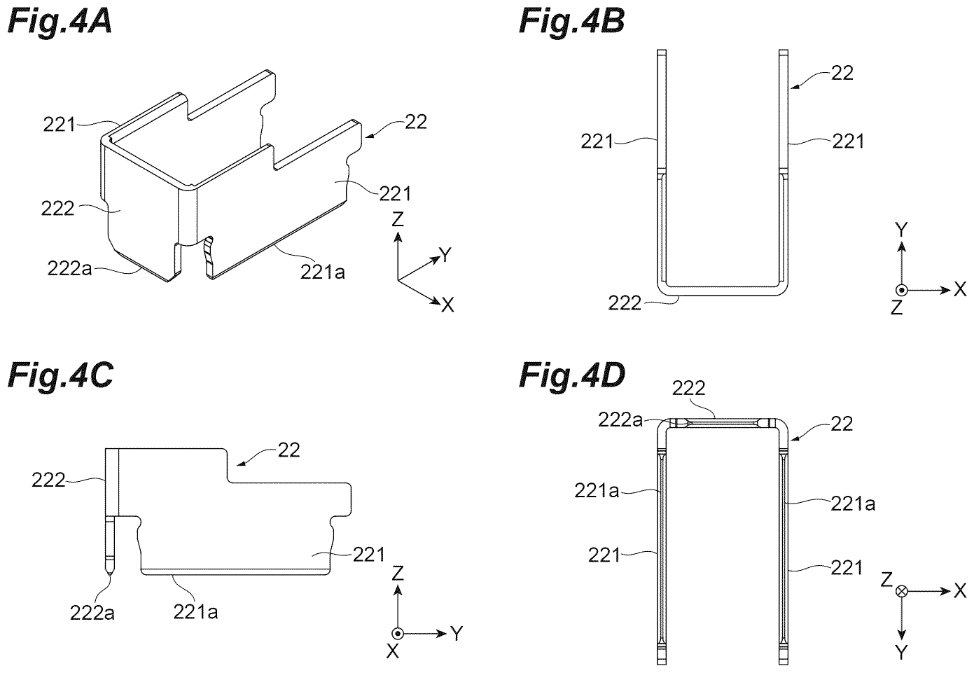

FIG. 4A is a perspective view illustrating an example of the appearance of the first shell 22. FIG. 4B is a plan view illustrating an example of the appearance of the first shell 22. FIG. 4C is a side view illustrating an example of the appearance of the first shell 22. FIG. 4D is a bottom view illustrating an example of the appearance of the first shell 22.

As illustrated in FIG. 4B and FIG. 4D, the first shell 22 has a so-called U-shape or H-shape when viewed from the fitting direction. The first shell 22 is formed by, for example, performing bending processing or the like on a punched metal plate. The first shell 22 includes a pair of first side surfaces 221 facing each other and a first coupling surface 222 coupling the pair of first side surfaces 221. The first shell 22 does not have a surface facing the first coupling surface 222.

As illustrated in FIG. 4A, the pair of first side surfaces 221 has a flat plate shape extending in the Y-axis direction and the Z-axis direction. Each of the pair of first side surfaces 221 includes a ground connection portion 221a that faces the first board 200 and is formed along the Y-axis direction. The ground connection portion 221a is electrically connected to the ground conductors of the first board 200.

The first coupling surface 222 has a flat plate shape extending in the X-axis direction and the Z-axis direction. The first coupling surface 222 couples the pair of first side surfaces 221 at both ends of the first coupling surface 222 in the X-axis direction. The first coupling surface 222 includes a ground connection portion 222a that faces the first board 200 and is formed along the X-axis direction. The ground connection portion 222a is electrically connected to the ground conductors of the first board 200.

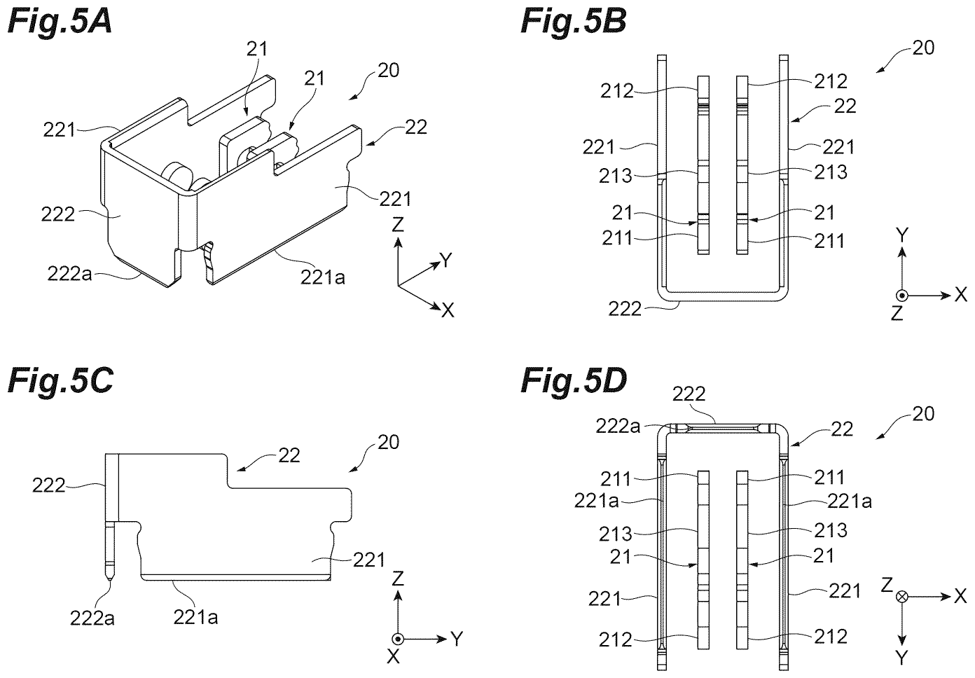

FIG. 5A is a perspective view illustrating an example of the appearance of the first unit 20. FIG. 5B is a plan view illustrating an example of the appearance of the first unit 20. FIG. 5C is a side view illustrating an example of the appearance of the first unit 20. FIG. 5D is a bottom view illustrating an example of the appearance of the first unit 20.

The pair of first side surfaces 221 faces each other with the pair of first contacts 21 interposed therebetween in the arrangement direction of the pair of first contacts 21. The pair of first side surfaces 221 is disposed so as to cover the pair of first contacts 21 in the arrangement direction of the pair of first contacts 21. As illustrated in FIG. 5B, the total length of the pair of first side surfaces 221 in the Y-axis direction is longer than the total length of the pair of first contacts 21 in the Y-axis direction. As illustrated in FIG. 5D, the total length of the ground connection portion 221a in the Y-axis direction is longer than the total length of the pair of first contacts 21 in the Y-axis direction.

The first coupling surface 222 faces the first contact portions 211 of the pair of first contacts 21 in the Y-axis direction. The first coupling surface 222 is disposed so as to cover the first contact portions 211 of the pair of first contacts 21 in the Y-axis direction. As illustrated in FIG. 5D, the total length of the ground connection portion 222a in the X-axis direction is longer than the distance between the pair of first contacts 21 disposed in the X-axis direction.

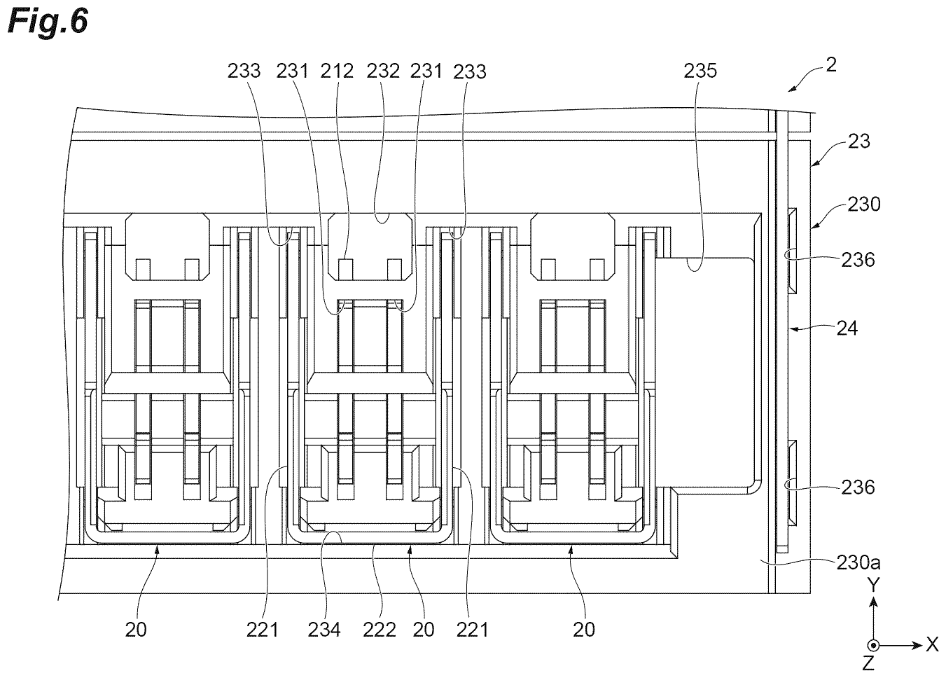

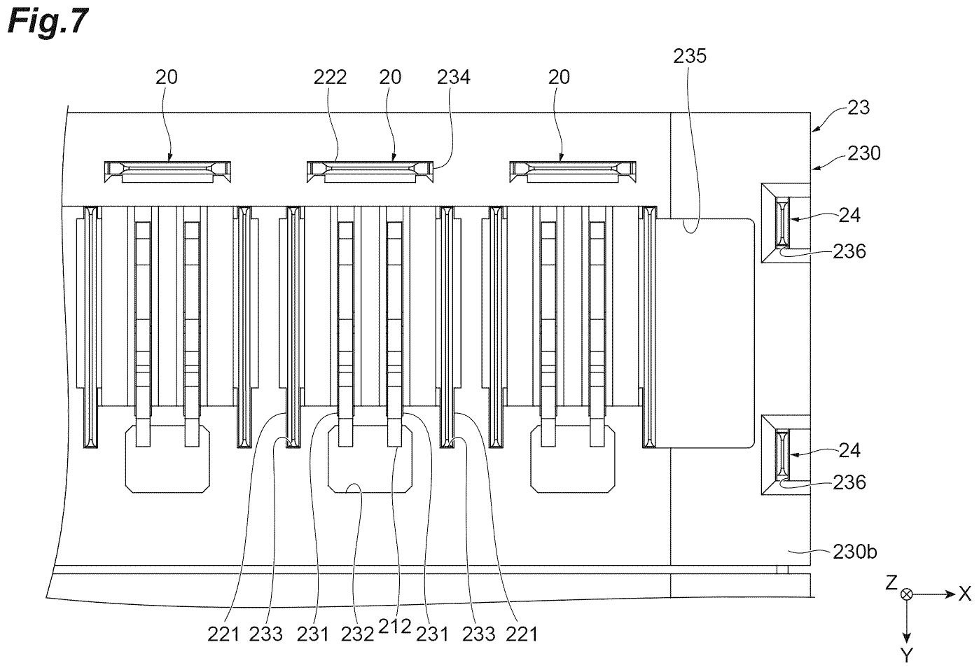

The first housing 23 will be described with reference to FIGS. 6 and 7. FIG. 6 is an enlarged plan view illustrating an example of a part of the appearance of the electric connector 2 in an enlarged manner. FIG. 7 is an enlarged bottom view illustrating an example of a part of the appearance of the electric connector 2 in an enlarged manner. When viewed from the fitting direction, the first housing 23 takes on a form approximating a rectangular shape. Each of the blocks 230 of the first housing 23 includes a main surface 230a and a back surface 230b that extend in a planar shape along the first board 200.

The main surface 230a is a surface facing the mating connector 3 when fitted to the mating connector 3. The back surface 230b is a surface facing the first board 200. Each of the blocks 230 is formed with, for each of the plurality of first units 20, a pair of inner grooves 231, a window 232, a pair of outer grooves 233, a coupling groove 234, a fitting hole 235, and an engagement groove 236 that penetrate so as to connect between the main surface 230a and the back surface 230b.

The pair of inner grooves 231 is so formed that the pair of first contacts 21 is disposed therein. The window 232 is a hole that exposes the first connection leg portion 212 of the first contact 21 when viewed from the fitting direction. The pair of outer grooves 233 is so formed that the pair of inner grooves 231 is interposed therebetween in the arrangement direction of the pair of first contacts 21. In the pair of outer grooves 233, the pair of first side surfaces 221 of the first shell 22 is accommodated. The coupling groove 234 is a groove that couples the pair of outer grooves 233. In the coupling groove 234, the first coupling surface 222 of the first shell 22 is accommodated. The fitting hole 235 is fitted to a fitting protrusion 334, described later, when the electric connector 2 and the mating connector 3 are fitted to each other. In a case where the plurality of blocks 230 is arranged in the Y-axis direction to manufacture the electric connector 2, the fitting hole 235 enables positioning between the blocks 230 by fitting a protrusion of a jig (not illustrated) on which the blocks 230 are placed into the fitting hole 235. In the engagement groove 236, the first side shell 24 is accommodated. One or more engagement grooves 236 may be provided per block 230. For example, a plurality of engagement grooves 236 is provided at predetermined intervals in the Y-axis direction.

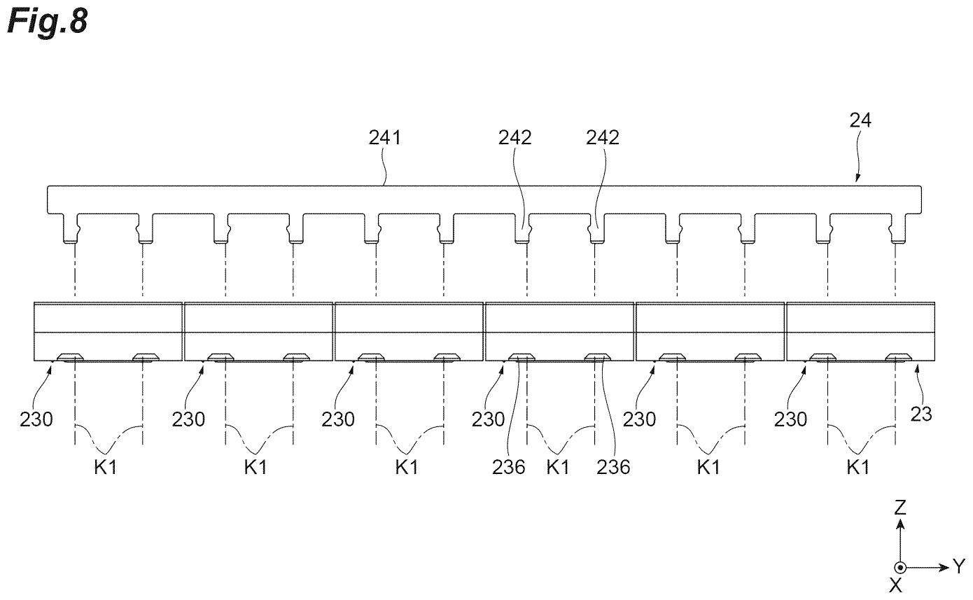

FIG. 8 is a side view illustrating an example of coupling by the first side shell 24. The first side shell 24 has a comb-like shape. The first side shell 24 is formed of, for example, a metal plate. The first side shell 24 includes a coupling plate 241 and a protrusion 242. The coupling plate 241 has an elongated plate-like shape and extends in a planar shape in the Y-axis direction. The protrusions 242 protrude toward the engagement grooves 236 of the plurality of blocks 230 in the fitting direction. The protrusions 242 are provided so as to correspond to the number of engagement grooves 236. For example, the plurality of protrusions 242 is provided at predetermined intervals in the Y-axis direction. The plurality of protrusions 242 is accommodated in the plurality of engagement grooves 236 by press-fitting for each axis K1 along the fitting direction.

### Mating Connector

FIG. 9 is a plan view of the mating connector 3. FIG. 9 illustrates a state in which the top and bottom are inverted in the fitting direction. That is, FIG. 9 corresponds to a plan view seen from the electric connector 2 along the fitting direction. The mating connector 3 is, for example, a plug connector, and is mounted on the second board 300. The second board 300 is, for example, a printed circuit board. The second board 300 is formed with a plurality of signal conductors and a plurality of ground conductors (not illustrated). The mating connector 3 includes a pair of second contacts 31, a second shell 32, a second housing 33, and a pair of second side shells 34. The mating connector 3 includes a plurality of second units 30 each of which includes the pair of second contacts 31 and the second shell 32.

The pair of second contacts 31 is formed of a conductive metal plate, for example, and is electrically connected to the signal conductors of the second board 300. The pair of second contacts 31 transmits a plurality of types of differential signals. Examples of the plurality of types of differential signals include a high-speed signal and a low-speed signal. The pair of second contacts 31 is disposed side by side while being spaced apart from each other along the X-axis direction.

The second shell 32 is formed of a conductive metal plate, for example, and is electrically connected to the ground conductors of the second board 300. The second shell 32 partially covers the periphery of the pair of second contacts 31 around an axis L along the fitting direction. For example, the second shell 32 covers the periphery of the pair of second contacts 31 from two directions in the X-axis direction and one direction in the Y-axis direction. The second shell 32 is not tubular.

The second housing 33 is formed of an insulating resin, for example, and holds therein the pair of second contacts 31 and the second shell 32 in an insulated state. The second housing 33 holds therein the plurality of second units 30. The second housing 33 includes a plurality of blocks 330 each of which holds therein the plurality of second units 30 along the X-axis direction and which is arranged side by side along the Y-axis direction. When viewed from the fitting direction, each of the blocks 330 takes on a form approximating a concave shape.

The plurality of second units 30 is disposed along a direction orthogonal to the fitting direction and a direction orthogonal to the arrangement direction of the pair of second contacts 31, and is also disposed along the arrangement direction of the pair of second contacts 31. That is, the plurality of second units 30 is disposed along the Y-axis direction and the X-axis direction. The number of second units 30 is not limited. In one example, the number of second units 30 may be 60. In this case, 10 second units 30 disposed along the X-axis direction may be arranged in 6 sets along the Y-axis direction. An interval D3 between the plurality of second units 30 adjacent to each other in the X-axis direction may be smaller than an interval D4 between the plurality of second units 30 adjacent to each other in the Y-axis direction.

The pair of second side shells 34 is formed of a conductive metal plate, for example, and is a coupling member that couples the plurality of blocks 330 of the second housing 33 along the Y-axis direction. The pair of second side shells 34 is disposed at both ends of the plurality of blocks 330 in the X-axis direction. The pair of second side shells 34 engages with each of the plurality of blocks 330 to couple the plurality of blocks 330.

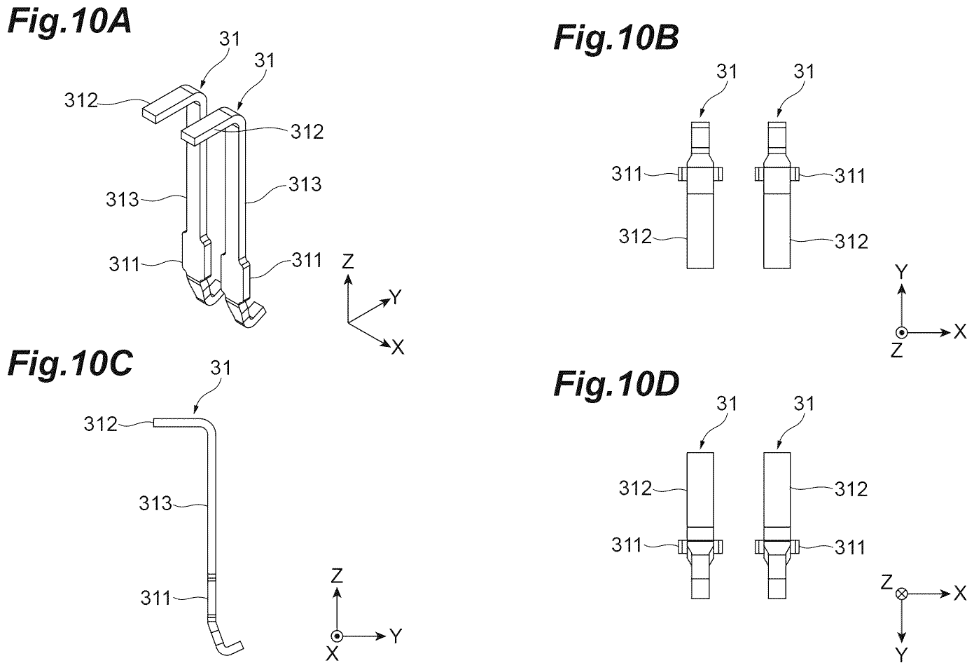

FIG. 10A is a perspective view illustrating an example of the appearance of the pair of second contacts 31. FIG. 10B is a plan view illustrating an example of the appearance of the pair of second contacts 31. FIG. 10C is a side view illustrating an example of the appearance of the pair of second contacts 31. FIG. 10D is a bottom view illustrating an example of the appearance of the pair of second contacts 31.

As illustrated in FIG. 10C, the pair of second contacts 31 extends along the Z-axis direction when viewed from the arrangement direction. The pair of second contacts 31 takes on a form approximating an S shape when viewed from the arrangement direction. The pair of second contacts 31 is formed by, for example, performing bending processing or the like on a punched metal plate. Each of the pair of second contacts 31 includes a second contact portion 311, a second connection leg portion 312, and a second coupling portion 313.

The second contact portion 311 has a flat plate shape extending along the Z-axis direction. The second connection leg portion 312 extends along the second board 300 and is electrically connected to the signal conductors of the second board 300. The second coupling portion 313 extends along the Z-axis direction and couples the second contact portion 311 and the second connection leg portion 312.

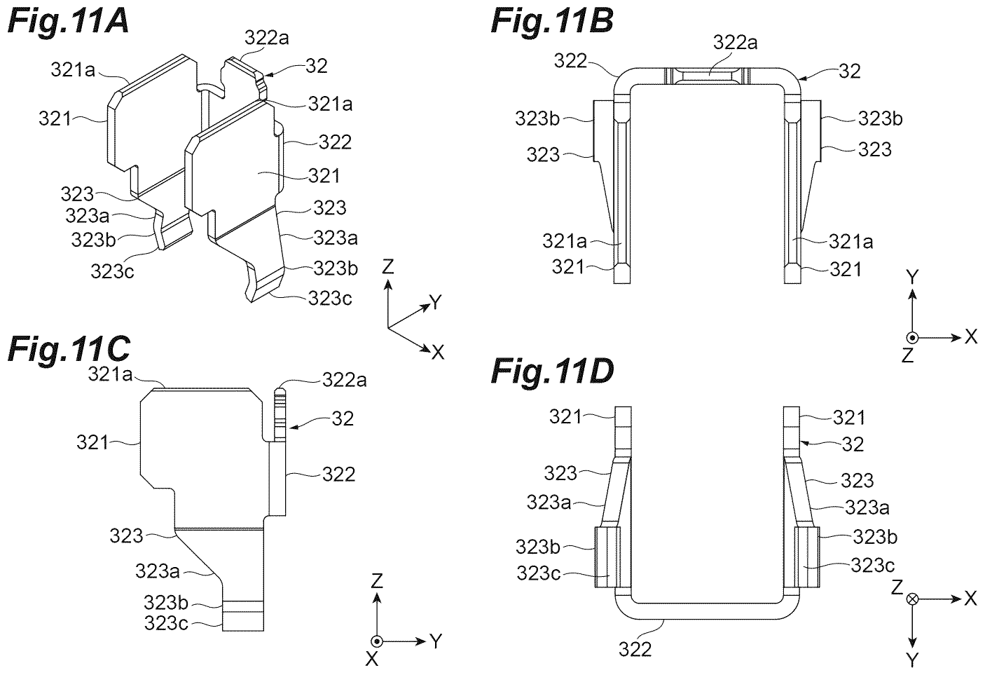

FIG. 11A is a perspective view illustrating an example of the appearance of the second shell 32. FIG. 11B is a plan view illustrating an example of the appearance of the second shell 32. FIG. 11C is a side view illustrating an example of the appearance of the second shell 32. FIG. 11D is a bottom view illustrating an example of the appearance of the second shell 32.

As illustrated in FIG. 11B and FIG. 11D, the second shell 32 has a so-called U-shape or H-shape when viewed from the fitting direction. The second shell 32 is formed by, for example, performing bending processing or the like on a punched metal plate. The second shell 32 includes a pair of second side surfaces 321 facing each other and a second coupling surface 322 coupling the pair of second side surfaces 321. The second shell 32 does not have a surface facing the second coupling surface 322.

As illustrated in FIG. 11A, the pair of second side surfaces 321 has a flat plate shape extending in the Y-axis direction and the Z-axis direction. Each of the pair of second side surfaces 321 includes a ground connection portion 321a that faces the second board 300 and is formed along the Y-axis direction. The ground connection portion 321a is electrically connected to the ground conductors of the second board 300. The pair of second side surfaces 321 includes a pair of protrusions 323 protruding away from the second board 300.

The pair of protrusions 323 functions as a so-called leaf spring. The pair of protrusions 323 is curved so as to be spaced apart from each other in the X-axis direction as being away from the second board 300 along the fitting direction. Each of the pair of protrusions 323 includes a base portion 323a, a contact portion 323b, and a tip portion 323c. The base portion 323a, the contact portion 323b, and the tip portion 323c are provided in this order away from the second board 300. The base portions 323a are inclined so as to be spaced apart from each other. The contact portions 323b are portions that are furthest apart from each other. The tip portions 323c are inclined so as to be closer to each other. The protrusion 323 is formed to be gradually wider from the tip portion 323c toward the base portion 323a. That is, the protrusion 323 is wider toward the first board 200.

The second coupling surface 322 has a flat plate shape extending in the X-axis direction and the Z-axis direction. The second coupling surface 322 couples the pair of second side surfaces 321 at both ends of the second coupling surface 322 in the X-axis direction. The second coupling surface 322 includes a ground connection portion 322a that faces the second board 300 and is formed along the X-axis direction. The ground connection portion 322a is electrically connected to the ground conductors of the second board 300.

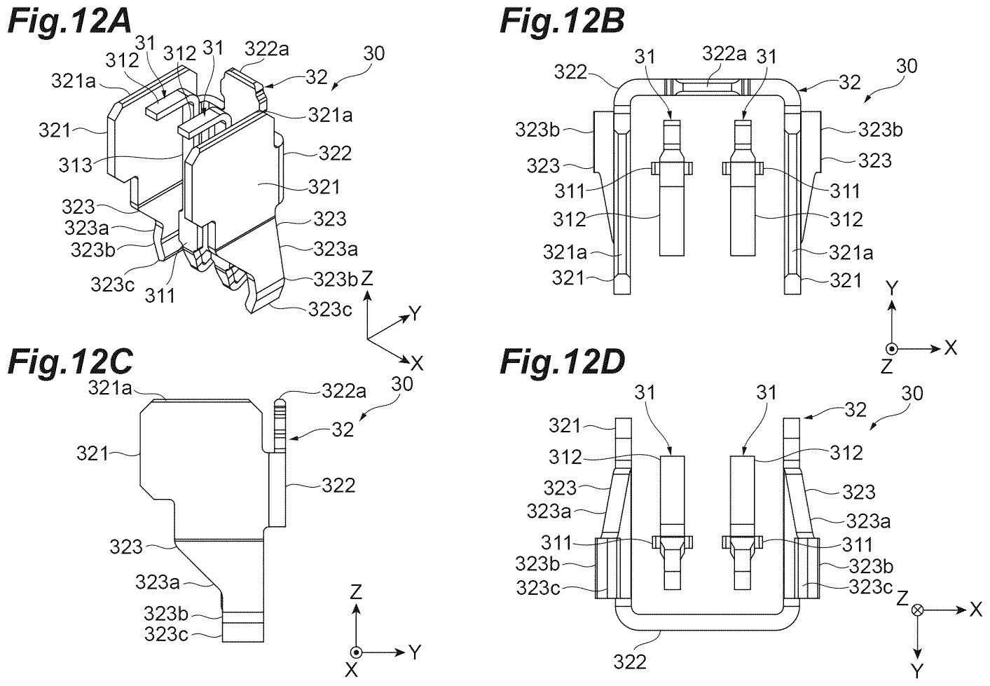

FIG. 12A is a perspective view illustrating an example of the appearance of the second unit 30. FIG. 12B is a plan view illustrating an example of the appearance of the second unit 30. FIG. 12C is a side view illustrating an example of the appearance of the second unit 30. FIG. 12D is a bottom view illustrating an example of the appearance of the second unit 30.

The pair of second side surfaces 321 faces each other with the pair of second contacts 31 interposed therebetween in the arrangement direction of the pair of second contacts 31. The pair of second side surfaces 321 is disposed so as to cover the pair of second contacts 31 in the arrangement direction of the pair of second contacts 31. As illustrated in FIG. 12B, the total length of the pair of second side surfaces 321 in the Y-axis direction is longer than the total length of the pair of second contacts 31 in the Y-axis direction. The total length of the ground connection portion 321a in the Y-axis direction is longer than the total length of the second connection leg portion 312 in the Y-axis direction.

The protrusions 323 face the second contact portions 311 of the pair of second contacts 31 in the arrangement direction of the pair of second contacts 31. The protrusions 323 are disposed so as to cover the second contact portions 311 in the arrangement direction of the pair of second contacts. As illustrated in FIG. 12C, the total length of the pair of second side surfaces 321 in the Z-axis direction is longer than the total length of the pair of second contacts 31 in the Z-axis direction.

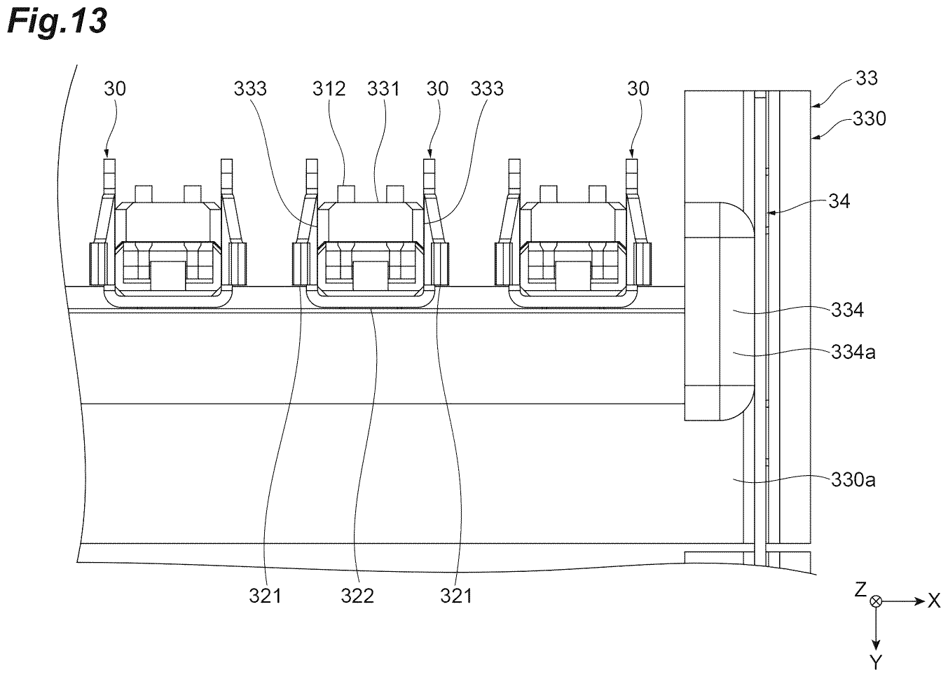

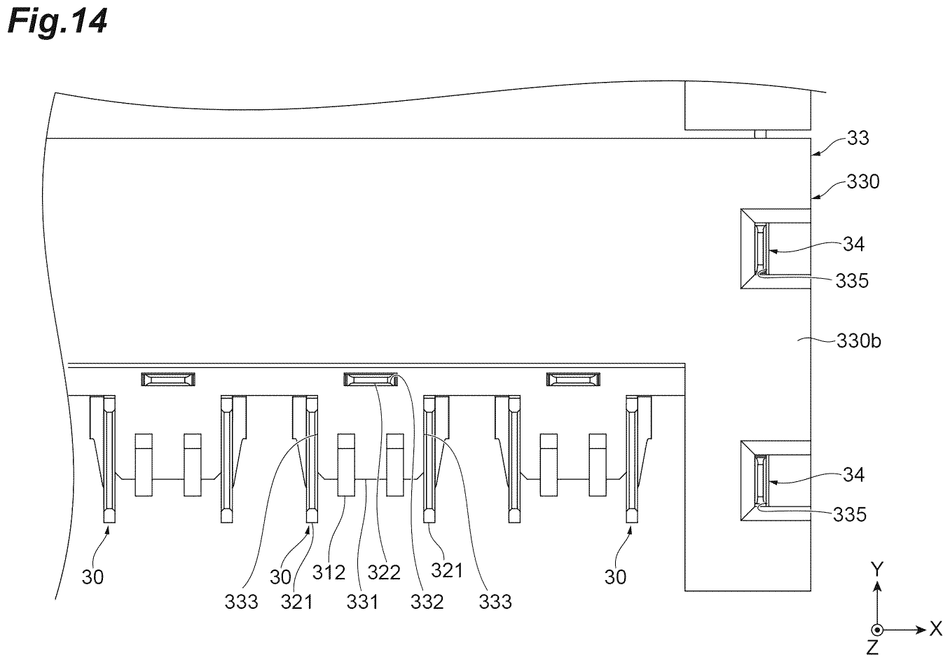

The second housing 33 will be described with reference to FIGS. 13 and 14. FIG. 13 is an enlarged plan view illustrating an example of a part of the appearance of the mating connector 3 in an enlarged manner. FIG. 14 is an enlarged bottom view illustrating an example of a part of the appearance of the mating connector 3 in an enlarged manner. When viewed from the fitting direction, the second housing 33 takes on a form approximating a rectangular shape. Each of the blocks 330 of the second housing 33 includes a main surface 330a and a back surface 330b that extend in a planar shape along the second board 300.

The main surface 330a is a surface facing the electric connector 2 when fitted to the electric connector 2. The back surface 330b is a surface facing the second board 300. Each of the blocks 330 is formed with, for each of the plurality of second units 30, a columnar portion 331 and an engagement groove 335 that connect the main surface 330a and the back surface 330b. The columnar portion 331 is formed with a hole 332 penetrating so as to connect the main surface 330a and the back surface 330b. The columnar portion 331 is also provided with a pair of side surfaces 333 provided so as to be orthogonal to the X-axis direction. Each of the blocks 330 includes, at both ends in the X-axis direction, fitting protrusions 334 protruding away from the second board 300 with the main surface 330a as a base end.

The columnar portion 331 is formed in a prismatic shape by, for example, insert molding along the arrangement of the pair of second contacts 31. The columnar portion 331 accommodates the second coupling portions 313 of the pair of second contacts 31, and exposes the second connection leg portions 312 of the pair of second contacts 31 from the back surface 330b. In the hole 332, a part of the second shell 32 is accommodated. The hole 332 accommodates a part of the second coupling surface 322, and exposes the ground connection portion 322a from the back surface 330b. The pair of side surfaces 333 comes into contact with the pair of second side surfaces 321 of the second shell 32. The fitting protrusion 334 has a columnar shape. The fitting protrusion 334 has a curved surface 334a connecting the tip and the side surface. The length from the main surface 330a to the tip of the fitting protrusion 334 may be longer than the length from the main surface 330a to the tip (tip portion 323c) of the second unit 30. The fitting protrusion 334 may protrude beyond the second unit 30. The fitting protrusion 334 is fitted into the fitting hole 235 when fitted to the electric connector 2. The fitting protrusion 334 and the fitting hole 235 function as guides at the time of fitting the electric connector 2 and the mating connector 3. The curved surface 334a of the fitting protrusion 334 may slide when coming into contact with the main surface 230a in the vicinity of the fitting hole 235 of the first housing 23 to align the fitting protrusion 334 and the fitting hole 235. In the engagement groove 335, the second side shell 34 is accommodated. One or more engagement grooves 335 may be provided per block 330. For example, a plurality of engagement grooves 335 is provided at predetermined intervals in the Y-axis direction.

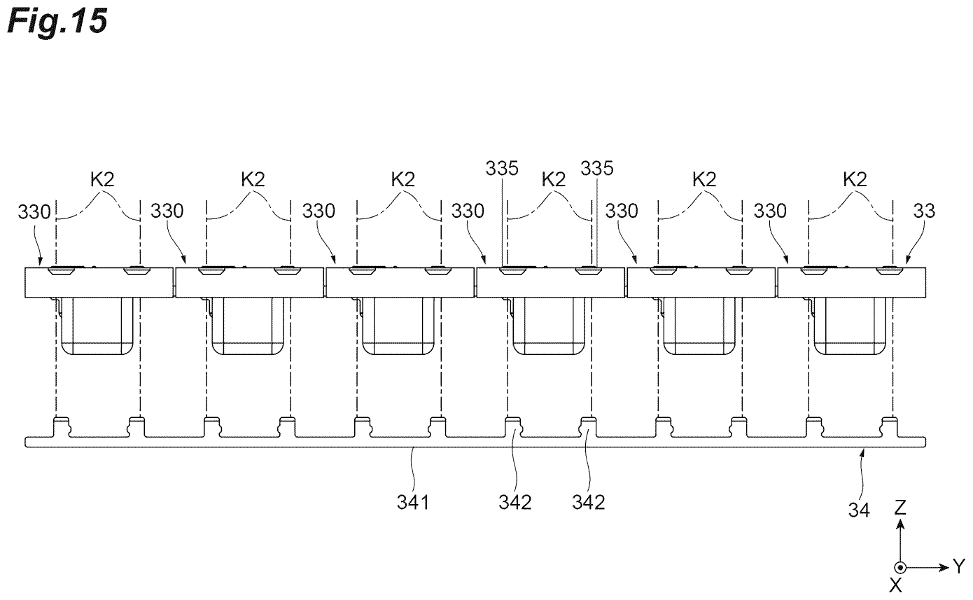

FIG. 15 is a side view illustrating an example of coupling by the second side shell 34. The second side shell 34 has a comb-like shape. The second side shell 34 is formed of, for example, a metal plate. The second side shell 34 includes a coupling plate 341 and a protrusion 342. The coupling plate 341 has an elongated plate-like shape and extends in a planar shape in the Y-axis direction. The protrusions 342 protrude toward the engagement grooves 335 of the plurality of blocks 330 in the fitting direction. The protrusions 342 are provided so as to correspond to the number of engagement grooves 335. For example, the plurality of protrusions 342 is provided at predetermined intervals in the Y-axis direction. The plurality of protrusions 342 is accommodated in the plurality of engagement grooves 236 by press-fitting for each axis K2 along the fitting direction.

### Fitted State

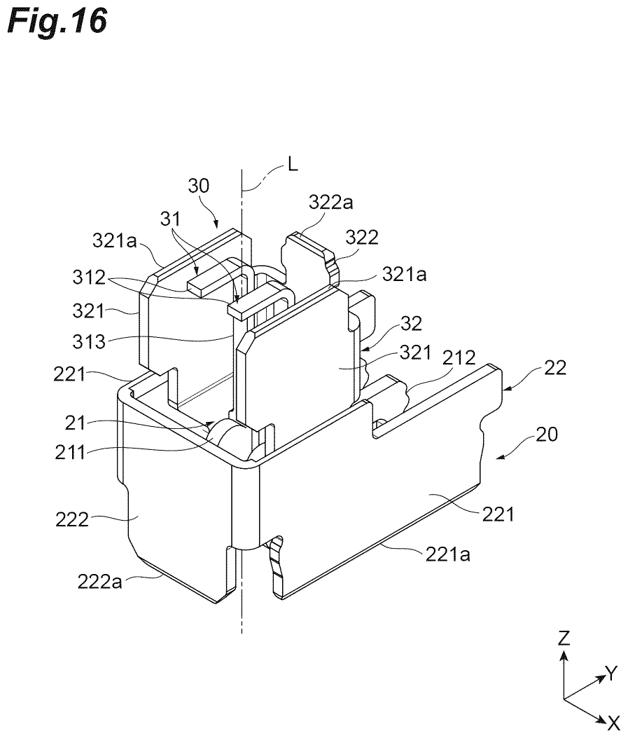

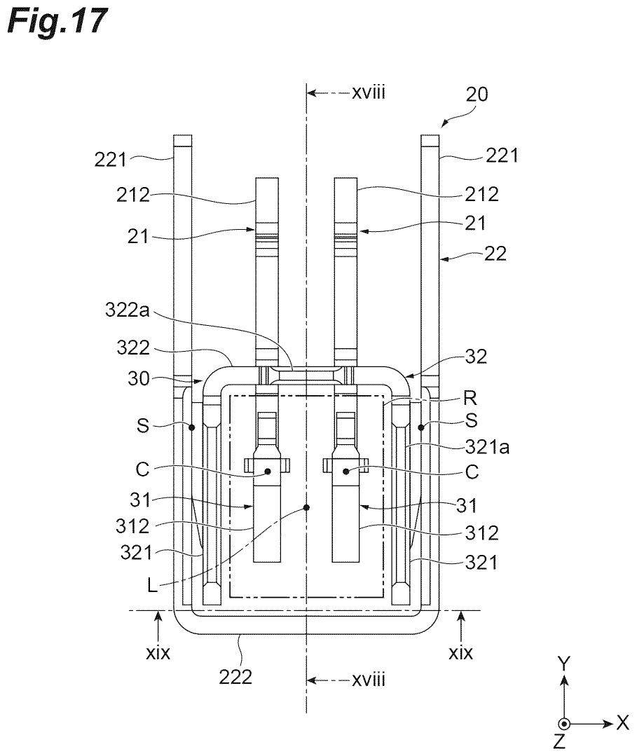

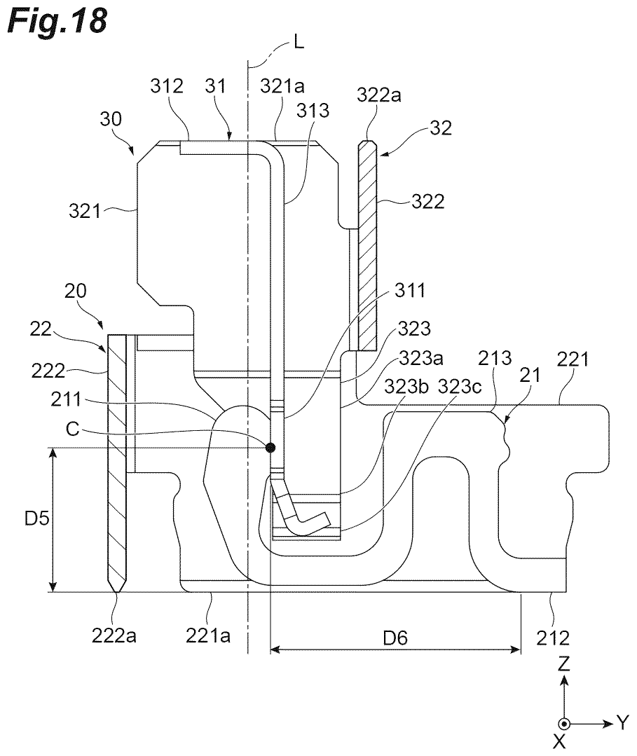

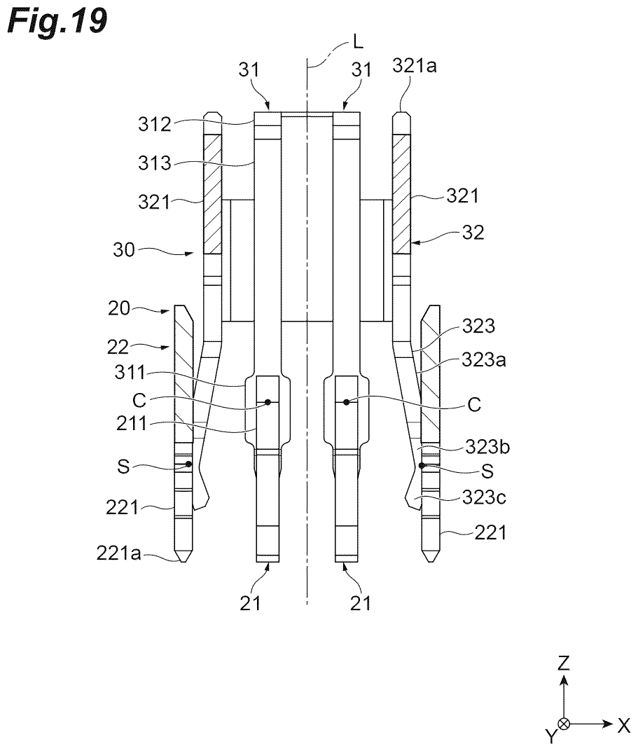

A state where the electric connector 2 and the mating connector 3 are fitted to each other (hereinafter, the state is referred to as a “fitted state”) will be described in detail with reference to FIGS. 16 to 19. FIG. 16 is a perspective view illustrating an example of the appearance of the first unit 20 and the second unit 30 in a fitted state. FIG. 17 is a plan view illustrating an example of the appearance of the first unit 20 and the second unit 30 in a fitted state. FIG. 18 is a cross-sectional view illustrating a cross section taken along the line xviii-xviii of FIG. 17. FIG. 19 is a cross-sectional view illustrating a cross section taken along the line xix-xix of FIG. 17. In FIGS. 16 to 19, the first housing 23, the second housing 33, the first board 200, and the second board 300 are not illustrated.

As illustrated in FIG. 16, in the fitted state, the first coupling surface 222 does not face the second connection leg portion 312. The first coupling surface 222 opens the second connection leg portion 312. The second coupling surface 322 does not face the first connection leg portion 212. The second coupling surface 322 opens the first connection leg portion 212. In the fitted state, the first coupling surface 222 and the second coupling surface 322 do not face each other when viewed from the direction orthogonal to the fitting direction and the arrangement direction of the pair of first contacts 21. That is, the first coupling surface 222 and the second coupling surface 322 do not face each other in the Y-axis direction. In the fitted state, the first coupling surface 222 is not in contact with the second shell 32.

As illustrated in FIG. 17, when viewed from the fitting direction in the fitted state, a region R surrounded by the first shell 22 and the second shell 32 is formed. When viewed from the fitting direction in the fitted state, the region R is formed by fitting the first coupling surface 222 of the first shell 22 and the second coupling surface 322 of the second shell 32 so as to face each other. When viewed from the fitting direction in the fitted state, the pair of first contacts 21 is electrically connected to the signal conductors of the first board 200 outside the region R surrounded by the first shell 22 and the second shell 32. When viewed from the fitting direction in the fitted state, the pair of first contacts 21 passes between the second coupling surface 322 and the first board 200, extends outside the region R surrounded by the first shell 22 and the second shell 32, and is electrically connected to the signal conductors of the first board 200. When viewed from the fitting direction in the fitted state, the pair of second contacts 31 is electrically connected to the signal conductors of the second board 300 in the region R.

When viewed from the fitting direction in the fitted state, the pair of first contacts 21 and the pair of second contacts 31 come into contact with each other in the region R. As illustrated in FIG. 18, in the fitted state, the pair of first contacts 21 and the pair of second contacts 31 come into contact with each other to form a contact touching portion C. The contact touching portion C is a contact point between the first contact portions 211 of the pair of first contacts 21 and the second contact portions 311 of the pair of second contacts 31. In the fitted state, the first contact portions 211 do not face the second coupling surface 322 with the second contact portions 311 interposed therebetween.

Soldering is performed on a contact point of the first connection leg portion 212 with the first board 200. A distance D5 between the first board 200 and the contact touching portion C is smaller than a distance D6 between the contact point of the first connection leg portion 212 with the first board 200 and the contact touching portion C. This may prevent so-called solder rise in which the solder applied between the first connection leg portion 212 and the first board 200 reaches the contact touching portion C.

Returning to FIG. 17, when viewed from the fitting direction in the fitted state, the first shell 22 and the second shell 32 surround the contact touching portion C where the pair of first contacts 21 and the pair of second contacts 31 come into contact with each other around the axis L. When viewed from the fitting direction in the fitted state, the pair of first side surfaces 221, the pair of second side surfaces 321, the first coupling surface 222, and the second coupling surface 322 surround the contact touching portion C around the axis L. When viewed from the fitting direction in the fitted state, the contact touching portion C is formed in the region R surrounded by the first shell 22 and the second shell 32.

The pair of first side surfaces 221 faces each other with the first connection leg portions 212 interposed therebetween in the arrangement direction of the pair of first contacts 21. The pair of second side surfaces 321 faces each other with the second connection leg portions 312 interposed therebetween in the arrangement direction of the pair of second contacts 31. In the fitted state, the pair of first side surfaces 221 faces each other with the contact touching portion C interposed therebetween in the arrangement direction of the pair of first contacts 21, and the pair of second side surfaces 321 faces each other with the contact touching portion C interposed therebetween in the arrangement direction of the pair of second contacts 31.

In the fitted state, the first connection leg portions 212 and the second connection leg portions 312 extend in directions away from each other. For example, the first connection leg portions 212 extend in the positive direction of the Y axis, and the second connection leg portions 312 extend in the negative direction of the Y axis.

As illustrated in FIG. 19, in the fitted state, the first shell 22 comes into contact with the second shell 32 so as to sandwich the second shell 32 to form shell touching portions S. Each of the shell touching portions S is a contact point between the pair of first side surfaces 221 of the first shell 22 and the pair of second side surfaces 321 of the second shell 32. Each of the shell touching portions S is a contact point between the pair of first side surfaces 221 and the pair of protrusions 323 of the pair of second side surfaces 321. The shell touching portions S are closer to the first board 200 than the contact touching portions C.

The pair of protrusions 323 elastically deforms to come into contact with the pair of first side surfaces 221. At the time of fitting, the tip portions 323c of the pair of protrusions 323 come into contact with the first shell 22 and slide in accordance with the inclination, thereby functioning as a guide for alignment. The contact portions 323b of the pair of protrusions 323 come into contact with the pair of first side surfaces 221 in a pressing manner.

### Summary

The above examples include the following configurations.

(1) A connector device 1 including an electric connector 2 mounted on a first board 200; and a mating connector 3 mounted on a second board 300 and fitted to the electric connector 2, in which the electric connector 2 includes: a pair of conductive first contacts 21 electrically connected to a signal conductor of the first board 200; a conductive first shell 22 electrically connected to a ground conductor of the first board 200 and partially covering a periphery of the pair of first contacts 21 around an axis L along a fitting direction between the electric connector 2 and the mating connector 3; and a first housing 23 configured to hold the pair of first contacts 21 and the first shell 22 in an insulated state, the mating connector 3 includes: a pair of conductive second contacts 31 electrically connected to a signal conductor of the second board 300; a conductive second shell 32 electrically connected to a ground conductor of the second board 300 and partially covering a periphery of the pair of second contacts 31 around the axis; and a second housing 33 configured to hold the pair of second contacts 31 and the second shell 32 in an insulated state, the pair of first contacts 21 comes into contact with the pair of second contacts 31 and the first shell 22 comes into contact with the second shell 32 in a fitted state where the electric connector 2 and the mating connector 3 are fitted to each other, and the first shell 22 and the second shell 32 surround a contact touching portion C where the pair of first contacts 21 and the pair of second contacts 31 come into contact with each other around the axis when viewed from the fitting direction in the fitted state.

In the electric connector 2, the first shell 22 partially covers the periphery of the pair of first contacts 21 around the axis. This enables simplifying the first shell 22 as compared with a case where the first shell 22 covers the entire periphery of the pair of first contacts 21 around the axis. In the mating connector 3, the second shell 32 partially covers the periphery of the pair of second contacts 31 around the axis. This enables simplifying the second shell 32 as compared with a case where the second shell 32 covers the entire periphery of the pair of second contacts 31 around the axis. When viewed from the fitting direction in the fitted state, the first shell 22 and the second shell 32 surround the contact touching portion C around the axis. This improves the shielding performance in the fitted state.

(2) The connector device 1 according to (1), in which the first shell 22 includes a pair of first side surfaces 221 facing each other and a first coupling surface 222 coupling the pair of first side surfaces 221, the second shell 32 includes a pair of second side surfaces 321 facing each other and a second coupling surface 322 coupling the pair of second side surfaces 321, and the pair of first side surfaces 221, the pair of second side surfaces 321, the first coupling surface 222, and the second coupling surface 322 surround the contact touching portion C around the axis when viewed from the fitting direction in the fitted state. The first shell 22 has a so-called U-shape or H-shape with the pair of first side surfaces 221 and the first coupling surface 222. The second shell 32 has a so-called U-shape or H-shape with the pair of second side surfaces 321 and the second coupling surface 322. Such shapes of the first shell 22 and the second shell 32 may be readily manufactured by, for example, performing bending processing or the like on a punched metal plate. This enables simplifying the first shell 22 and the second shell 32. Further, when viewed from the fitting direction in the fitted state, the pair of first side surfaces 221, the pair of second side surfaces 321, the first coupling surface 222, and the second coupling surface 322 surround the periphery of the contact touching portion C around the axis. This improves the shielding performance in the fitted state.

(3) The connector device 1 according to (2), in which the pair of second side surfaces 321 includes a pair of protrusions 323 protruding away from the second board 300, the pair of protrusions 323 comes into contact with the pair of first side surfaces 221 in the fitted state, and a shell touching portion S where the pair of protrusions 323 and the pair of first side surfaces 221 come into contact with each other is closer to the first board 200 than the contact touching portion C. In the fitted state, the pair of protrusions 323 is in contact with the pair of first side surfaces 221 at a position closer to the first board 200 than the contact touching portion C. The distance between the second board 300 and the first board 200 is reduced and the length of the pair of protrusions 323 is increased in the direction from the second board 300 toward the first board 200, which increases the elastic force of the pair of protrusions 323.

(4) The connector device 1 according to any one of (1) to (3), in which when viewed from the fitting direction in the fitted state, the pair of first contacts 21 is electrically connected to the signal conductor of the first board 200 outside a region surrounded by the first shell 22 and the second shell 32. In the region surrounded by the first shell 22 and the second shell 32, the pair of first contacts 21 comes into contact with the pair of second contacts 31. The pair of first contacts 21 is electrically connected to the signal conductor of the first board 200 outside the region surrounded by the first shell 22 and the second shell 32. That is, the pair of first contacts 21 is formed both inside and outside the region surrounded by the first shell 22 and the second shell 32. In such a pair of first contacts 21, the length from the contact point with the pair of second contacts 31 to the contact point with the signal conductor of the first board 200 increases, so that the elastic force of the pair of first contacts 21 may be increased.

(5) The connector device 1 according to any one of (1) to (4), in which the electric connector 2 includes a plurality of first units 20 each of which includes the pair of first contacts 21 and the first shell 22, the plurality of first units 20 is disposed along a direction orthogonal to the fitting direction and a direction orthogonal to an arrangement direction of the pair of first contacts 21, and is disposed along the arrangement direction of the pair of first contacts 21, the mating connector 3 includes a plurality of second units 30 each of which includes the pair of second contacts 31 and the second shell 32, and the plurality of second units 30 is disposed along a direction orthogonal to the fitting direction and a direction orthogonal to an arrangement direction of the pair of second contacts 31, and is disposed along the arrangement direction of the pair of second contacts 31. In the fitted state, the shielding performance may be achieved for each of the plurality of first units 20 and the plurality of second units 30. As a result, the intervals D1 and D2 between the first units 20 and the intervals D3 and D4 between the second units 30 may be reduced, which enables the electric connector 2 and the mating connector 3 to achieve higher density.

(6) The connector device 1 according to (2) or (3), in which the pair of first contacts 21 includes a first connection leg portion 212 extending along the first board 200 and electrically connected to the signal conductor of the first board 200, the pair of second contacts 31 includes a second connection leg portion 312 extending along the second board 300 and electrically connected to the signal conductor of the second board 300, and in the fitted state, the first connection leg portion 212 and the second connection leg portion 312 extend in directions away from each other. The first connection leg portion 212 and the second connection leg portion 312 extend in directions away from each other. Since the first connection leg portion 212 and the second connection leg portion 312 are spaced apart from each other, it may prevent the influence that the first connection leg portion 212 and the second connection leg portion 312 have on each other.

(7) The connector device 1 according to (6), in which the pair of first side surfaces 221 faces each other with the first connection leg portion 212 interposed therebetween in an arrangement direction of the pair of first contacts 21, the pair of second side surfaces 321 faces each other with the second connection leg portion 312 interposed therebetween in an arrangement direction of the pair of second contacts 31, and in the fitted state, the pair of first side surfaces 221 faces each other with the contact touching portion C interposed therebetween in the arrangement direction of the pair of first contacts 21, and the pair of second side surfaces 321 faces each other with the contact touching portion C interposed therebetween in the arrangement direction of the pair of second contacts 31. This improves the shielding performance in the arrangement direction of the pair of first contacts 21 and the pair of second contacts 31.

(8) The connector device 1 according to (6) or (7), in which, in the fitted state, the first coupling surface 222 does not face the second connection leg portion 312, and the second coupling surface 322 does not face the first connection leg portion 212. In the fitted state, the first coupling surface 222 opens the second connection leg portion 312, and the second coupling surface 322 opens the first connection leg portion 212. This improves the visibility of the first connection leg portion 212 and the second connection leg portion 312.

(9) The connector device 1 according to (2) or (3), in which, when viewed from the fitting direction in the fitted state, the pair of first contacts 21 passes between the second coupling surface 322 and the first board 200, extends outside a region surrounded by the first shell 22 and the second shell 32, and is electrically connected to the signal conductor of the first board 200. The pair of first contacts 21 is formed to extend between the second coupling surface 322 and the first board 200. That is, the pair of first contacts 21 is formed both inside and outside the region surrounded by the first shell 22 and the second shell 32. In such a pair of first contacts 21, the length from the contact point with the pair of second contacts 31 to the contact point with the signal conductor of the first board 200 increases, so that the elastic force of the pair of first contacts 21 may be increased.

(10) The connector device 1 according to (2) or (3), in which, in the fitted state, the first coupling surface 222 and the second coupling surface 322 do not face each other when viewed from a direction orthogonal to the fitting direction and a direction orthogonal to an arrangement direction of the pair of first contacts 21. In this case, the visibility of the pair of first contacts 21 and the pair of second contacts 31 is increased.

(11) The connector device 1 according to any one of (1) to (10), in which the first housing 23 is formed with a fitting hole 235 penetrating the first housing 23 so as to connect a main surface 230a facing the mating connector 3 when fitted to the mating connector 3 and a back surface 230b facing the first board 200, the second housing 33 is formed with a fitting protrusion 334 protruding away from the second board 300 with a main surface 330a facing the electric connector 2 when fitted to the electric connector 2 as a base end, and the fitting hole 235 and the fitting protrusion 334 are fitted to each other in the fitted state. In this case, the fitting protrusion 334 and the fitting hole 235 function as guides at the time of fitting the electric connector 2 and the mating connector 3. As a result, the reliability of the contact between the first contact 21 and the second contact 31 may be increased.

(12) An electric connector 2 mounted on a first board 200 and fitted to a mating connector 3 mounted on a second board 300, the electric connector 2 including: a pair of first contacts 21 electrically connected to a signal conductor of the first board 200; a first shell 22 electrically connected to a ground conductor of the first board 200 and partially covering a periphery of the pair of first contacts 21 around an axis L along a fitting direction between the electric connector 2 and the mating connector 3; and a housing (first housing 23) configured to hold the pair of first contacts 21 and the first shell 22 in an insulated state, in which the pair of first contacts 21 comes into contact with a pair of second contacts 31 of the mating connector 3 and the first shell 22 comes into contact with a second shell 32 of the mating connector 3 in a fitted state with the mating connector 3, and the first shell 22 and the second shell 32 surround a contact touching portion C where the pair of first contacts 21 and the pair of second contacts 31 come into contact with each other around the axis when viewed from the fitting direction in the fitted state.

In the electric connector 2, the first shell 22 partially covers the periphery of the pair of first contacts 21 around the axis. This enables simplifying the first shell 22 as compared with a case where the first shell 22 covers the entire periphery of the pair of first contacts 21 around the axis. When viewed from the fitting direction in the fitted state with the mating connector 3, the first shell 22 and the second shell 32 surround the contact touching portion C around the axis. This improves the shielding performance in the fitted state.

### MODIFIED EXAMPLES

It is to be understood that not all aspects, advantages and features described herein may necessarily be achieved by, or included in, any one particular example. Indeed, having described and illustrated various examples herein, it should be apparent that other examples may be modified in arrangement and detail.

In the above-described example, an example in which the electric connector 2 is a receptacle connector has been described, but the electric connector 2 may be a plug connector. The mating connector 3 may be a receptacle connector. Even in this example, according to the connector device 1, the electric connector 2, and the mating connector 3 of the present disclosure, the shell may be simplified.

In the above-described example, the plurality of blocks 230 and the plurality of blocks 330 are disposed in the same orientation, but the present disclosure is not limited thereto. For example, the plurality of blocks 230 and the plurality of blocks 330 may be disposed in different orientations. The plurality of blocks 230 and the plurality of blocks 330 may include blocks having different configurations. For example, the plurality of blocks 230 may hold the plurality of first contacts 21 without holding the first shell 22. The plurality of blocks 330 may hold the plurality of second contacts 31 without holding the second shell 32.

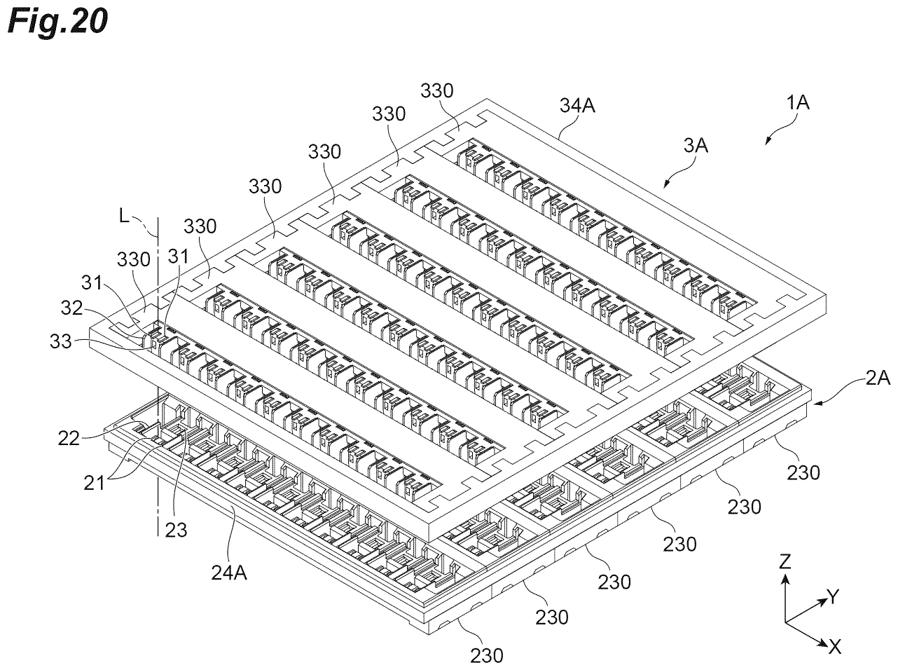

FIG. 20 is a perspective view illustrating an example of the appearance of a connector device 1A according to a modification. The connector device 1A is different from the connector device 1 in that the connector device 1A includes an electric connector 2A and a mating connector 3A. Hereinafter, differences of the connector device 1A from the connector device 1 will be described. The electric connector 2A includes a first frame 24A instead of the first side shell 24. The mating connector 3A includes a second frame 34A instead of the second side shell 34.

The first frame 24A is a coupling member that couples the plurality of blocks 230 of the first housing 23 along the Y-axis direction. The first frame 24A has a frame shape surrounding the plurality of blocks 230 in the X-axis direction and the Y-axis direction. The first frame 24A engages with each of the plurality of blocks 230 to couple the plurality of blocks 230. The first frame 24A is made of resin, for example. For example, the first frame 24A is formed by positioning the plurality of blocks 230 side by side, then housing the plurality of blocks 230 in a mold having cavities shaped like the first frame 24A, and injecting resin into the cavities.

The second frame 34A is a coupling member that couples the plurality of blocks 330 of the second housing 33 along the Y-axis direction. The second frame 34A has a frame shape surrounding the plurality of blocks 330 in the X-axis direction and the Y-axis direction. The second frame 34A engages with each of the plurality of blocks 330 to couple the plurality of blocks 330. The second frame 34A is made of resin, for example. For example, the second frame 34A is formed by positioning the plurality of blocks 330 side by side, then housing the plurality of blocks 330 in a mold having cavities shaped like the second frame 34A, and injecting resin into the cavities.

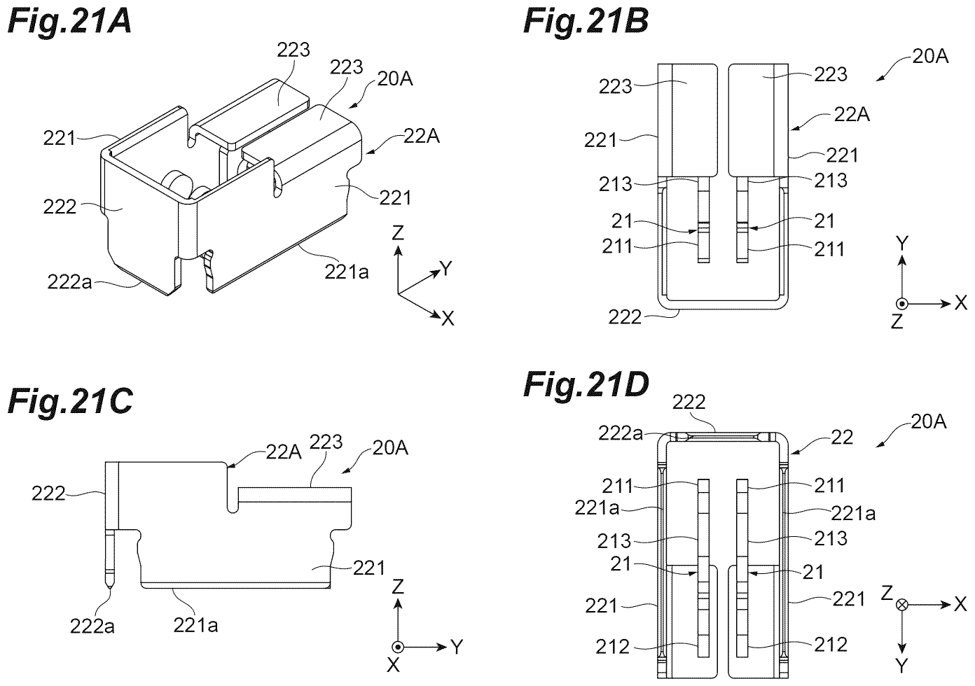

FIG. 21A is a perspective view illustrating an example of the appearance of the first unit 20A according to a modification. FIG. 21B is a plan view illustrating an example of the appearance of the first unit 20A according to the modification. FIG. 21C is a side view illustrating an example of the appearance of the first unit 20A according to the modification. FIG. 21D is a bottom view illustrating an example of the appearance of the first unit 20A according to the modification. The first unit 20A is different from the first unit 20 in that the first unit 20A includes a first shell 22A instead of the first shell 22. Differences of the first unit 20A from the first unit 20 will be described below. The first unit 20A includes a pair of first upper surfaces 223.

The pair of first upper surfaces 223 has a flat plate shape extending toward each other with upper ends of the pair of first side surfaces 221 as base ends. For example, the pair of first upper surfaces 223 is formed so as to bend from the upper end of one first side surface 221 toward the other first side surface 221 and face each other. The pair of first upper surfaces 223 is disposed above the first coupling portions 213 of the pair of first contacts 21 in the fitting direction. The pair of first upper surfaces 223 faces the first board 200 with the first coupling portion 213 interposed therebetween. The pair of first upper surfaces 223 is not positioned above the first contact portions 211 in the fitting direction. That is, the pair of first upper surfaces 223 does not face the first contact portions 211. According to such a configuration, the shielding property of the first unit 20A is increased.

1. A connector device comprising:
an electric connector mounted on a first board; and
a mating connector mounted on a second board and fitted to the electric connector,
wherein the electric connector comprises:
a pair of conductive first contacts electrically connected to a signal conductor of the first board,
a conductive first shell electrically connected to a ground conductor of the first board and partially covering a periphery of the pair of first contacts around an axis along a fitting direction between the electric connector and the mating connector, and
a first housing configured to hold the pair of first contacts and the first shell in an insulated state,
the mating connector comprises:
a pair of conductive second contacts electrically connected to a signal conductor of the second board,
a conductive second shell electrically connected to a ground conductor of the second board and partially covering a periphery of the pair of second contacts around the axis, and
a second housing configured to hold the pair of second contacts and the second shell in an insulated state,
wherein the pair of first contacts comes into contact with the pair of second contacts and the first shell comes into contact with the second shell in a fitted state where the electric connector and the mating connector are fitted to each other, and
wherein the first shell and the second shell surround a contact touching portion where the pair of first contacts and the pair of second contacts come into contact with each other around the axis when viewed from the fitting direction in the fitted state.

2. The connector device according to claim 1,
wherein when viewed from the fitting direction in the fitted state, the pair of first contacts is electrically connected to the signal conductor of the first board outside a region surrounded by the first shell and the second shell.

3. The connector device according to claim 1,
wherein the first housing is formed with a fitting hole penetrating the first housing so as to connect a main surface of the first housing facing the mating connector when fitted to the mating connector and a back surface facing the first board,
wherein the second housing is formed with a fitting protrusion that protrudes away from the second board using a main surface of the second housing facing the electric connector when fitted to the electric connector as a base end, and
wherein the fitting hole and the fitting protrusion are fitted to each other in the fitted state.

4. The connector device according to claim 1,
wherein the first shell covers at least three sides of the periphery of the pair of first contacts, and
wherein the three sides include a first side disposed along a first direction which is an arrangement direction of the pair of first contacts, a second side disposed along the first direction and facing the first side, and a third side disposed along a second direction which is a direction orthogonal to the first direction and the fitting direction.

5. The connector device according to claim 1,
wherein the first shell comprises a pair of first side surfaces facing each other and a first coupling surface coupling the pair of first side surfaces,
wherein the second shell comprises a pair of second side surfaces facing each other and a second coupling surface coupling the pair of second side surfaces, and
wherein the pair of first side surfaces, the pair of second side surfaces, the first coupling surface and the second coupling surface surround the contact touching portion around the axis when viewed from the fitting direction in the fitted state.

6. The connector device according to claim 5,
wherein the pair of second side surfaces comprises a pair of protrusions that protrude away from the second board,
wherein the pair of protrusions comes into contact with the pair of first side surfaces in the fitted state, and
wherein a shell touching portion where the pair of protrusions and the pair of first side surfaces come into contact with each other is closer to the first board than the contact touching portion.

7. The connector device according to claim 5,
wherein, when viewed from the fitting direction in the fitted state, the pair of first contacts passes between the second coupling surface and the first board, extends outside a region surrounded by the first shell and the second shell, and is electrically connected to the signal conductor of the first board.

8. The connector device according to claim 5,
wherein, in the fitted state, the first coupling surface and the second coupling surface do not face each other when viewed from a direction orthogonal to the fitting direction and an arrangement direction of the pair of first contacts.

9. The connector device according to claim 5,
wherein the pair of first contacts comprises a first connection leg portion extending along the first board and electrically connected to the signal conductor of the first board,
wherein the pair of second contacts comprises a second connection leg portion extending along the second board and electrically connected to the signal conductor of the second board, and
wherein in the fitted state, the first connection leg portion and the second connection leg portion extend in directions away from each other.

10. The connector device according to claim 9,
wherein, in the fitted state, the first coupling surface does not face the second connection leg portion, and the second coupling surface does not face the first connection leg portion.

11. The connector device according to claim 9,
wherein the pair of first side surfaces faces each other with the first connection leg portion interposed therebetween in a first direction which is an arrangement direction of the pair of first contacts,
wherein the pair of second side surfaces faces each other with the second connection leg portion interposed therebetween in the first direction, and
wherein in the fitted state, the pair of first side surfaces faces each other with the contact touching portion interposed therebetween in the first direction, and the pair of second side surfaces faces each other with the contact touching portion interposed therebetween in the first direction.

12. The connector device according to claim 11,
wherein, in the fitting direction, a length of the pair of second side surfaces is longer than a length of the pair of second contacts.

13. The connector device according to claim 11,
wherein, in a second direction which is a direction orthogonal to the first direction and the fitting direction, a length of the pair of first side surfaces is longer than a length of the pair of first contacts.

14. The connector device according to claim 13,
wherein the pair of first side surfaces comprises a ground connection portion that faces the first board and is formed along the second direction, and
wherein, in the second direction, a length of the ground connection portion is longer than a length of the pair of first contacts.

15. The connector device according to claim 13,
wherein the first coupling surface comprises a ground connection portion that face the first board and is formed along the first direction, and
wherein, in the first direction, a length of the ground connection portion is longer than a distance between the pair of first contacts.

16. The connector device according to claim 1,
wherein the electric connector comprises a plurality of first units each including the pair of first contacts and the first shell,
wherein the plurality of first units is disposed along a first direction which is the arrangement direction of the pair of first contacts, and is disposed along a second direction which is a direction orthogonal to the first direction and the fitting direction,
wherein the mating connector comprises a plurality of second units each including the pair of second contacts and the second shell, and
wherein the plurality of second units is disposed along the first direction and the second direction.

17. The connector device according to claim 16,
wherein the interval between the plurality of first units adjacent to each other in the first direction is smaller than the interval between the plurality of first units adjacent to each other in the second direction.

18. The connector device according to claim 16,
wherein the first housing comprises a plurality of blocks that hold the plurality of first units disposed along the first direction and are arranged side by side along the second direction.

19. The connector device according to claim 18, further comprising a conductive first side shell disposed at both ends of each block of the plurality of blocks in the first direction and connecting the plurality of blocks.

20. An electric connector mounted on a first board and fitted to a mating connector mounted on a second board,
the electric connector comprising:
a pair of conductive first contacts electrically connected to a signal conductor of the first board;
a conductive first shell electrically connected to a ground conductor of the first board and partially covering a periphery of the pair of first contacts around an axis along a fitting direction between the electric connector and the mating connector; and
a housing configured to hold the pair of first contacts and the first shell in an insulated state,
wherein the pair of first contacts comes into contact with a pair of conductive second contacts of the mating connector and the first shell comes into contact with a conductive second shell of the mating connector in a fitted state with the mating connector, and
wherein the first shell and the second shell surround a contact touching portion where the pair of first contacts and the pair of second contacts come into contact with each other around the axis when viewed from the fitting direction in the fitted state.
